(19) United States
(12) Patent Application Publication
(10) Pub. No.: US 2019/0055849 A1
(43) Pub. Date: Feb. 21, 2019

(54) LAMINATED AIRFOIL FOR A GAS TURBINE

(71) Applicant: Siemens Aktiengesellschaft, München (DE)

(72) Inventor: Allister William James, Chuluota, FL (US)

(73) Assignee: Siemens Aktiengesellschaft, Munchen (DE)

(21) Appl. No.: 15/770,842

(22) PCT Filed: Nov. 10, 2015
(86) PCT No.: PCT/US2015/059842

§ 371 Date: Apr. 25, 2018

(51) Int. Cl. F01D 9/04; F01D 25/12

(52) U.S. Cl. CPC F01D 9/041; F01D 25/12; F05D 2230/21; F05D 2230/40; F05D 2240/12; F05D 2220/32

(57) ABSTRACT

An airfoil (30) for a gas turbine (10) wherein the airfoil (30) includes an outer wall (32) having leading (34) and trailing (36) edges and convex (40) and concave (38) surfaces and wherein the outer wall (32) forms an internal cavity (52). The airfoil (30) includes at least one inner layer (42) located within the cavity (52), wherein the inner layer (42) has a shape that corresponds to the shape of the outer wall (32). The airfoil (30) also includes a leading edge insert (58) located adjacent the leading edge (34) of the outer wall (32). Further, the airfoil (30) includes a trailing edge insert (60) located adjacent the trailing edge (36) of the outer wall (32) wherein the at least one inner layer (42) is bonded to an inside surface (56) of the outer wall (32) to encapsulate the leading (58) and trailing (60) edge inserts.

### FIELD OF THE INVENTION

This invention relates to airfoils for gas turbine, and more particularly, to an airfoil having at least one inner layer located within a cavity of the airfoil, wherein the at least one inner layer is bonded to an inside surface of the outer wall to encapsulate at least one insert.

### BACKGROUND OF THE INVENTION

In various multistage turbomachines used for energy conversion, such as gas turbines, a fluid is used to produce rotational motion. Referring to FIG. 1, an axial flow gas turbine 10 includes a multi-stage compressor section 12, a combustion section 14, a multi stage turbine section 16 and an exhaust system 18 arranged along a center axis 20. Air at atmospheric pressure is drawn into the compressor section 12 generally in the direction of the flow arrows F along the axial length of the turbine 10. The intake air is progressively compressed in the compressor section 12 by rows of rotating compressor blades, thereby increasing pressure, and directed by mating compressor vanes to the combustion section 14, where it is mixed with fuel, such as natural gas, and ignited to create a combustion gas. The combustion gas, which is under greater pressure, temperature and velocity than the original intake air, is directed to the turbine section 16. The turbine section 16 includes a plurality of airfoil shaped turbine blades 22 arranged in a plurality of rows R1, R2, etc. on a shaft 24 that rotates about the axis 20. The combustion gas expands through the turbine section 16 where it is directed in a combustion flow direction F across the rows of blades 22 by associated rows of stationary vanes 24. A row of blades 22 and associated row of vanes 24 form a stage. In particular, the turbine section 16 may include four stages. As the combustion gas passes through the turbine section 16, the combustion gas causes the blades 22 and thus the shaft 24 to rotate about the axis 20, thereby extracting energy from the flow to produce mechanical work.

There are a number of challenges associated with the casting of thin wall airfoils for gas turbine blades, and these challenges are magnified as the component becomes larger. For example, there are limitations with respect to casting a desirable wall thickness due to the limited ability of the liquid alloy used in the casting process to flow and fill a mold cavity. Another challenge is that castings having an equiaxed grain structure require tapering to ensure that the entire mold used in the casting process is properly filled. In addition, grain boundaries formed during casting are a source of weakness and may lead to grain boundary cracking. Further, core shift during the casting process may result in core “kiss-out” or non-uniform wall thicknesses.

In the case of large turbine blades such as row 4 turbine blades, it is desirable that an upper section of the airfoil have relatively thin walls to reduce rotating mass of the blade. In particular, it is desirable that an upper one third of the airfoil have a wall thickness that is sufficiently thin (i.e. approximately 1 mm) so as to reduce the pull load on a disc that supports the turbine blades to acceptable levels. Since forming a thin wall having a suitable thickness by using a casting process is difficult, the airfoil walls are machined to the necessary thickness after casting. However, there are risks associated with this approach as the core may have shifted during casting, and thus the cast walls may not have a uniform thickness. As a consequence, wall thickness machining or trimming may result in over or under thinning of the walls.

### SUMMARY OF INVENTION

A laminated airfoil for a gas turbine is disclosed. The airfoil includes an outer wall having leading and trailing edges and convex and concave surfaces, wherein the outer wall forms an internal cavity. The airfoil also includes at least one inner layer located within the cavity. Further, the airfoil includes at least one insert located within the cavity, wherein the at least one inner layer is bonded to an inside surface of the outer wall to encapsulate the at least one insert.

In addition, a method for fabricating a laminated airfoil for a gas turbine is disclosed. The method includes providing an outer wall having leading and trailing edges and convex and concave surfaces, wherein the outer wall forms an internal cavity. The method also includes providing at least one inner layer located within the cavity and at least one insert located in the cavity. Further, the method includes bonding the at least one inner layer to an inside surface of the outer wall to encapsulate the at least one insert.

Those skilled in the art may apply the respective features of the present invention jointly or severally in any combination or sub-combination.

### BRIEF DESCRIPTION OF DRAWINGS

The teachings of the present disclosure can be readily understood by considering the following detailed description in conjunction with the accompanying drawings, in which:

FIG. 1 is a partial cross sectional view of an axial flow gas turbine.

FIG. 2 is a cross sectional view of an airfoil for a turbine blade in accordance with an embodiment of the invention.

FIG. 3 is a view of an outer wall of the airfoil.

FIG. 4 is a view of a first layer and the outer wall of the airfoil.

FIG. 5 depicts leading edge, trailing edge and mid-span inserts installed in a cavity of the airfoil.

FIG. 6 depicts an alternate embodiment of an airfoil that does not include the mid-span insert.

FIG. 7 depicts an alternate embodiment of an airfoil that includes a single first inner layer placed between the leading edge and mid-span inserts and a single second inner layer placed between the mid-span and trailing edge inserts.

FIG. 8 depicts an alternate embodiment of an airfoil that includes first and second interior inserts in addition to the leading edge and trailing edge inserts.

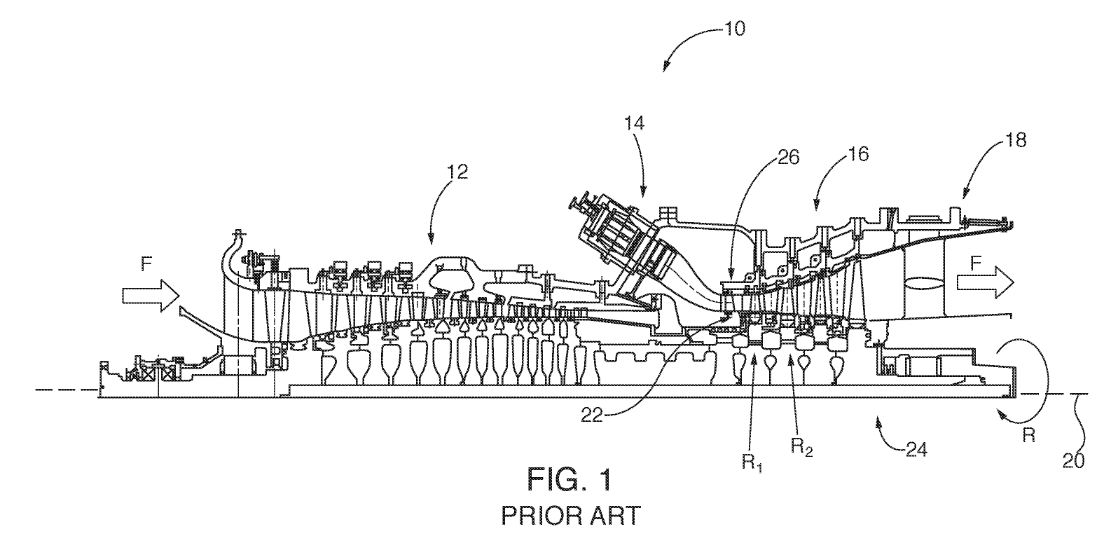

To facilitate understanding, identical reference numerals have been used, where possible, to designate identical elements that are common to the figures.

### DETAILED DESCRIPTION

Although various embodiments that incorporate the teachings of the present disclosure have been shown and described in detail herein, those skilled in the art can readily devise many other varied embodiments that still incorporate these teachings. The scope of the disclosure is not limited in its application to the exemplary embodiment details of construction and the arrangement of components set forth in the description or illustrated in the drawings. The disclosure encompasses other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

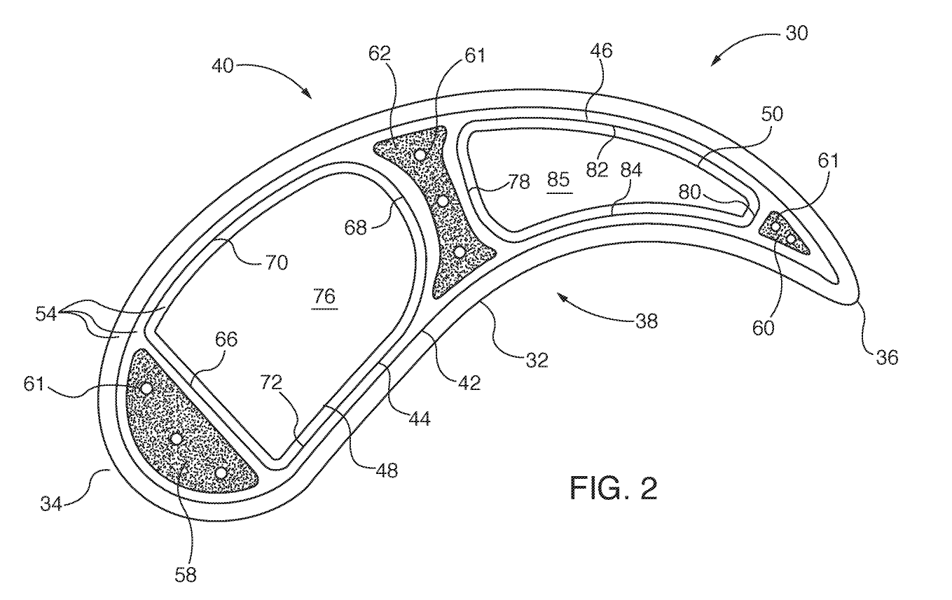

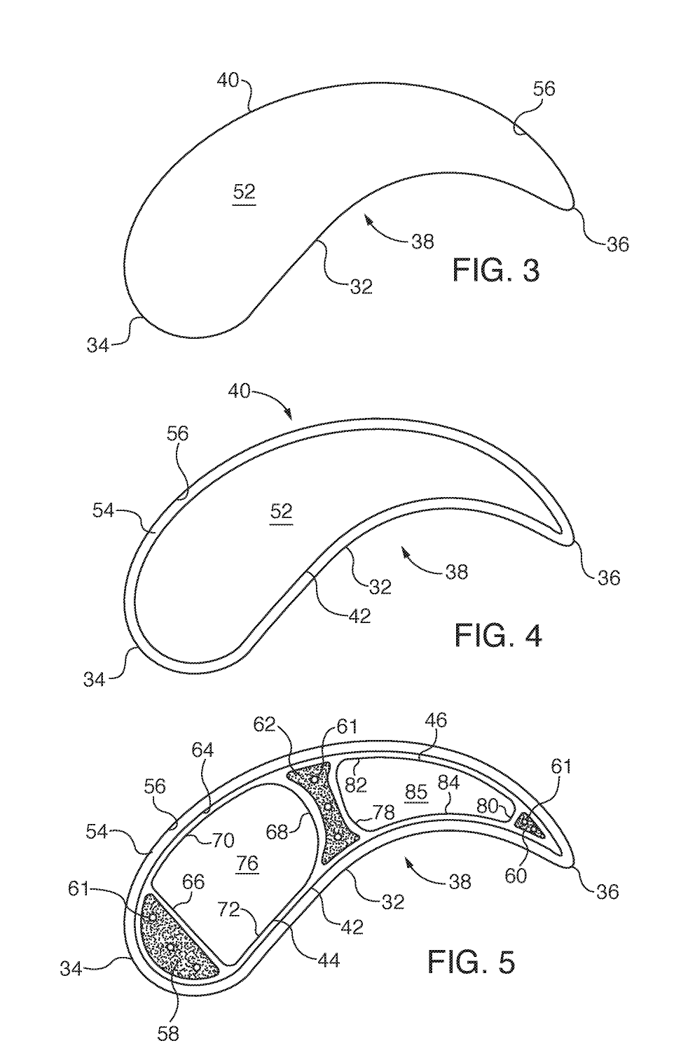

Referring to FIG. 2, a cross sectional view of an airfoil 30 for a turbine blade in accordance with an embodiment of the invention is shown. The airfoil 30 includes an outer skin or wall 32 having leading 34 and trailing 36 edges and a concave profile high-pressure side surface 38 and a convex profile low-pressure side surface 40. FIGS. 3-5 show various stages of assembly of the airfoil 30. Referring to FIG. 3, a view of only the outer wall 32 is shown. The outer wall 32 forms an internal airfoil cavity 52 for receiving laminate layers as will be described. The outer wall 32 may be cast or formed using a known process such as super plastic forming. In the case of a casting, a root section may be integrally cast with the airfoil.

A thickness of the outer wall 32 may be increased by adding at least one strengthening laminate layer fabricated from sheet alloy to form a laminated airfoil structure. The number of layers may be varied depending upon desired structural requirements. In an embodiment, the airfoil 30 includes first 42, second 44, third 46, fourth 48 and fifth 50 laminate layers. In accordance with aspects of the present invention, the layers 42, 44, 46, 48, 50 form a unitary structure although for purposes of illustration, individual layers 42, 44, 46, 48, 50 are depicted in FIGS. 2-8.

Referring to FIG. 4, a view of the first layer 42 and outer wall 32 is shown. The first layer 42 may be a preformed sheet alloy insert having a shape that corresponds to the shape of the leading 34 and trailing 36 edges and the concave 38 and convex 40 surfaces of the outer wall 32. The first layer 42 is then placed into the cavity 52 and bonded by a bonding layer 54 to an inner wall surface 56 of the outer wall 32. In an embodiment, a known explosive welding technique may be used to bond the first layer 42 to the inner wall surface 56. The outer wall 32 may be fabricated from a cast superalloy such as Alloy 247LC or IN738 Inconel® alloy or a wrought superalloy sheet material such as Hastelloy®-X alloy or Haynes® 282® alloy. The laminate layer may also be fabricated from a sheet material such as Hastelloy®-X alloy or Haynes® 282® alloy. In addition, dissimilar metals may be used although any thermal expansion mismatch between the materials should be minimal.

Referring to FIG. 5, at least one preformed strengthening insert is then placed within the cavity 52. Each insert strengthens the airfoil structure and is fixed in position with the addition of further layers of alloy sheet. In the embodiment shown in FIG. 5, leading edge 58, trailing edge 60 and mid-span 62 inserts are shown installed in the cavity 52. The leading 58 and trailing 60 edge inserts are located adjacent the leading 34 and trailing 36 edges, respectively, of the outer wall 32 whereas the mid-span insert 62 is located at an approximately midway location between the leading 58 and trailing 60 edge inserts. The inserts 58, 60, 62 may each include a solid material, metallic foam, or an engineered structure fabricated by three dimensional (i.e. 3D) printing or combinations thereof. For example, the inserts 58, 60, 62 could be a lattice structure manufactured using an additive manufacturing technique such as selective laser melting. In addition, at least one insert 58, 60, 62 may include at least one cooling passage 61 or cooling channel. Further, at least one insert 58, 60, 62 may be configured as an air bladder. With respect to air bladders, the disclosure of International Application No. PCT/US2015/029673, Siemens docket number 2015P01005WO, entitled TURBINE AIRFOIL WITH INTERNAL COOLING SYSTEM HAVING COOLING CHANNELS DEFINED IN PART BY AN INNER BLADDER is hereby incorporated by reference in its entirety. For example, the bladder may be a sheet metal preform that is inserted into a cavity and then expanded to form a layer of the airfoil 30. In addition, a hollow insert could also be used as an insert to form a hollow cavity.

The second 44 and third 46 layers are then placed in the cavity 52 and within the first layer 42. The second layer 44 includes spaced apart first 66 and second 68 end portions and spaced apart first 70 and second 72 side portions that form a cavity 76. In addition, the third layer 46 includes spaced apart third 78 and fourth 80 end portions and spaced apart third 82 and fourth 84 side portions that form a cavity 85. The second layer 44 is then placed between the leading edge 58 and mid-span 62 inserts such that the first 66 and second 68 end portions are located adjacent the leading edge 58 and mid-span 62 inserts, respectively. In addition, the third layer 46 is placed between the mid-span 62 and trailing edge 60 inserts such that the third 78 and fourth 80 end portions are located adjacent the mid-span 62 and trailing edge 60 inserts, respectively. The second 44 and third 46 layers are then bonded to an inner surface 64 of the first layer 42 by explosive welding, for example. This encapsulates the leading edge insert 58 between the first 42 and second 44 layers, the trailing edge insert 60 between the first 42 and third 46 layers and the mid-span insert between the first 42, second 44 and third 46 layers.

Referring back to FIG. 2, the fourth layer 48 has a shape that corresponds to the first 66 and second 68 end portions and the first 70 and second 72 side portions of the second layer 44. In addition, the fifth layer 50 has a shape that corresponds to the third 78 and fourth 80 end portions and spaced apart third 82 and fourth 84 side portions of the third layer 46. The fourth 48 and fifth 50 layers are then placed in the cavities 76, 82, respectively, and are bonded to the second 44 and third 46 layers by explosion welding to form the airfoil 30.

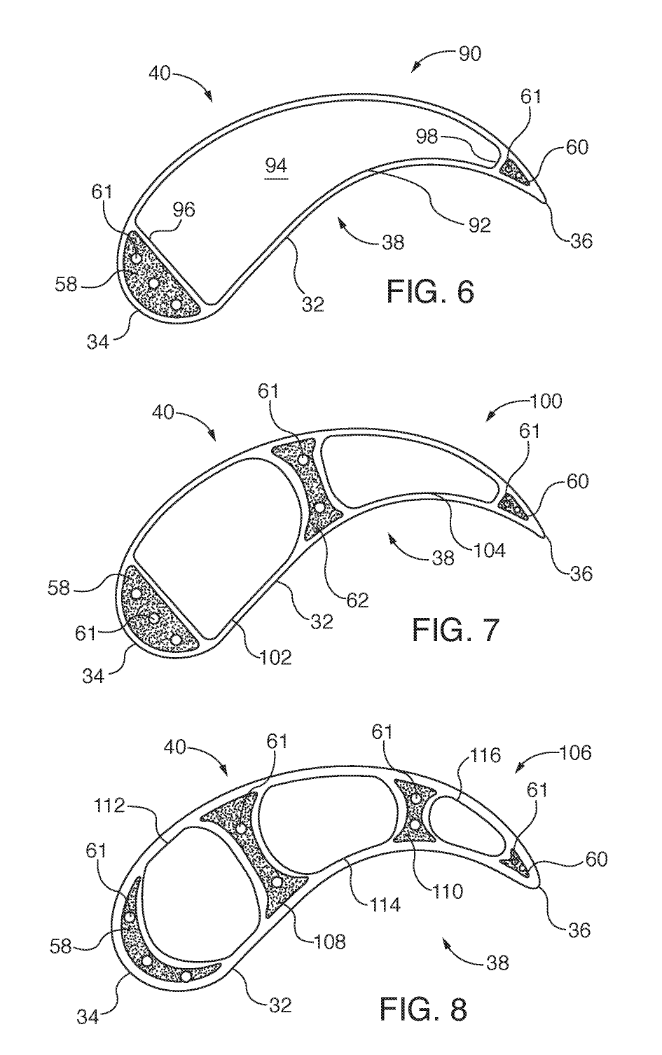

Referring to FIGS. 6-8, alternate embodiments of an airfoil are shown. FIG. 6 depicts an embodiment for an airfoil 90 that does not include the mid-span insert 62. In particular, the airfoil 90 includes a single inner layer 92 that forms a cavity 94. The inner layer 92 includes first 96 and second 98 ends located adjacent the leading edge 58 and trailing edge 60 inserts, respectively. FIG. 7 depicts an embodiment for an airfoil 100 having a single inner layer 102 placed between the leading edge 58 and mid-span 62 inserts and a single inner layer 104 placed between the mid-span 62 and trailing edge 60 inserts. FIG. 8 depicts an embodiment for an airfoil 106 that includes first 108 and second 110 interior inserts in addition to the leading edge 58 and trailing edge 60 inserts. In particular, the airfoil 106 includes a first inner layer 112 placed between the leading edge 58 and the first interior insert 108, a second inner layer 114 placed between the first 108 and second 110 interior inserts and a third inner layer 116 located between the second interior insert 110 and the trailing edge insert 60.

Aspects of the current invention enable the manufacture of large turbine blades, such as row 4 turbine blades, having thin walls without requiring machining or trimming the walls. While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An airfoil for a gas turbine, comprising;
an outer wall having leading and trailing edges and convex and concave surfaces, wherein the outer wall forms an internal cavity;
at least one inner layer located within the cavity; and
at least one insert located in the cavity, wherein the at least one inner layer is bonded to an inside surface of the outer wall to encapsulate the at least one insert.

2. The airfoil according to claim 1, wherein the at least one insert includes leading and trailing edge inserts.

3. The airfoil according to claim 1, wherein the at least one insert includes a mid-span insert.

4. The airfoil according to claim 3, wherein at least one layer includes a second layer for encapsulating the mid-span insert.

5. The airfoil according to claim 2, wherein the at least one insert includes first and second interior inserts.

6. The airfoil according to claim 1, wherein the at least one inner layer is bonded to the inside surface of the outer wall by explosive welding.

7. The airfoil according to claim 1, wherein the at least one insert includes a solid material, metallic foam, or lattice structure.

8. The airfoil according to claim 1, wherein the at least one insert includes at least one cooling passage.

9. An airfoil for a gas turbine, comprising;
an outer wall having leading and trailing edges and convex and concave surfaces, wherein the outer wall forms an internal cavity;
at least one inner layer located within the cavity, wherein the inner layer has a shape that corresponds to the shape of the outer wall;
a leading edge insert located adjacent the leading edge of the outer wall; and
a trailing edge insert located adjacent the trailing edge of the outer wall wherein the at least one inner layer is bonded to an inside surface of the outer wall to encapsulate the leading and trailing edge inserts.

10. The airfoil according to claim 9, wherein the airfoil further includes a mid-span insert.

11. The airfoil according to claim 10, wherein at least one layer includes a second layer for encapsulating the mid-span insert.

12. The airfoil according to claim 9, wherein the airfoil includes further first and second interior inserts.

13. The airfoil according to claim 9, wherein the at least one inner layer is bonded to the inside surface of the outer wall by explosive welding.

14. The airfoil according to claim 9, wherein the leading and trailing edge inserts include a solid material, metallic foam, or lattice structure.

15. The airfoil according to claim 9, wherein the leading and trailing edge inserts include at least one cooling passage.

16. A method for fabricating an airfoil for a gas turbine, comprising;
providing an outer wall having leading and trailing edges and convex and concave surfaces, wherein the outer wall forms an internal cavity;
providing at least one inner layer located within the cavity;
providing at least one insert located in the cavity; and
bonding the at least one inner layer to an inside surface of the outer wall to encapsulate the at least one insert.

17. The method according to claim 16, wherein the at least one insert includes leading and trailing edge inserts.

18. The method according to claim 16, wherein the at least one insert includes a mid-span insert.

19. The method according to claim 16, wherein the at least one insert includes first and second interior inserts.

20. The method according to claim 16, wherein the at least one inner layer is bonded to the inside surface of the outer wall by explosive welding.
